(19) United States
(12) Patent Application Publication
(10) Pub. No.: US 2026/0010603 A1
(43) Pub. Date: Jan. 8, 2026

(54) SYSTEM, INFORMATION PROCESSING DEVICE, PROGRAM, AND MANAGEMENT METHOD

(71) Applicant: SoftBank Corp., Tokyo (JP)

(72) Inventors: Kazuto SUDA, Tokyo (JP); Yuko ISHIWAKA, Tokyo (JP); Minoru OWADA, Tokyo (JP)

(21) Appl. No.: 19/326,775

(22) Filed: Sep. 12, 2025

Related U.S. Application Data
(63) Continuation of application No. PCT/JP2023/044050, filed on Dec. 8, 2023.

(30) Foreign Application Priority Data
Mar. 30, 2023 (JP) 2023-055326

(51) Int. Cl. G06F 21/32

(52) U.S. Cl. CPC G06F 21/32

(57) ABSTRACT

A system comprising an origin node having an origin storage unit storing a plurality of pieces of target-related data and a plurality of bottom nodes is provided, each of the plurality of bottom nodes has: a bottom storage unit which stores target-related data received from the origin node; a service provision unit which, if the target-related data corresponding to the provision target, which is the target to which the service is provided, is stored in the bottom storage unit, provides a service using the target-related data to the provision target; and if the target-related data corresponding to the target is not stored in the bottom storage unit and is stored in the origin node, provides a service using the target-related data stored in the origin node to the provision target and stores the target-related data in the bottom storage unit.

The contents of the following patent application(s) are incorporated herein by reference:
NO. 2023-055326 filed in JP on Mar. 30, 2023
NO. PCT/JP2023/044050 filed in WO on Dec. 8, 2023.

### BACKGROUND

### 1. Technical Field

The present invention relates to a system, an information processing device, a program, and a management method.

### 2. Related Art

Patent Document 1 describes a technique for acquiring a face image of a user and authenticating the user by using the data related to feature points included in the face image.

### RELATED ART DOCUMENTS

### Patent Document

Patent Document 1: Japanese Patent Application Publication No. 2021-170205

### BRIEF DESCRIPTION OF THE DRAWINGS

FIG. 1 schematically illustrates an example of a management method for face authentication data.

FIG. 2 schematically illustrates an example of the management method for face authentication data.

FIG. 3 schematically illustrates an example of the management method for face authentication data.

FIG. 4 schematically illustrates an example of a system 10.

FIG. 5 schematically illustrates an example of the system 10.

FIG. 6 schematically illustrates an example of the functional configuration of an origin node 100.

FIG. 7 schematically illustrates an example of the functional configuration of a bottom node 300.

FIG. 8 schematically illustrates an example of the functional configuration of a relay node 200.

FIG. 9 schematically illustrates an example of the hardware configuration of a computer 1200 that functions as the origin node 100, the relay node 200, or the bottom node 300.

### DESCRIPTION OF EXEMPLARY EMBODIMENTS

The present invention will be described below through embodiments of the invention, but the following embodiments do not limit the invention according to the claims. In addition, not all combinations of features described in the embodiments are essential to a solution of the invention.

The authentication accuracy in the authentication technique, such as face authentication, depends on the number of registrations of authentication data. The response time of authentication also depends on the number of registrations of authentication data. The risk of data leak also depends on the number of registrations of authentication data. For the authentication technique, the recognition rate is important, but the number of misrecognitions is often emphasized. For example, in an authentication system in which a false acceptance rate (FAR) is 0.05%, 2,000 authentications cause one misrecognition and 2,000,000 authentications cause 1,000 misrecognitions. Although the recognition rate is 0.05%, the fact that 1,000 misrecognitions occurred may be focused and lead to the judgment that the performance is insufficient. In order to limit the number of misrecognitions to two when performing 2,000,000 authentications, FAR of 0.0001% is needed, but achieving this FAR is not easy. In order to reduce the number of misrecognitions, the number of pieces of authentication data as the population for the authentication process is preferably small.

There are some possible methods as the management methods for managing authentication data. Herein, the management method for the face authentication data for the face authentication of the employees in one company is described as an example.

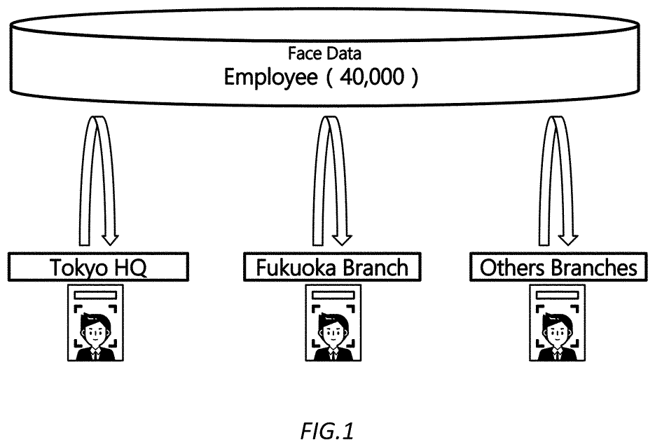

In the example illustrated in FIG. 1, the face authentication data of all 40,000 employees is stored in one server, and the authentication device arranged in each site performs authentication by referring to the face authentication data stored in the server via the network. According to the present example, because the number of pieces of authentication data as the population for the authentication process is the maximum number, the number of misrecognitions is relatively high, and the response time may be slow. In addition, the response time greatly depends on the network environment.

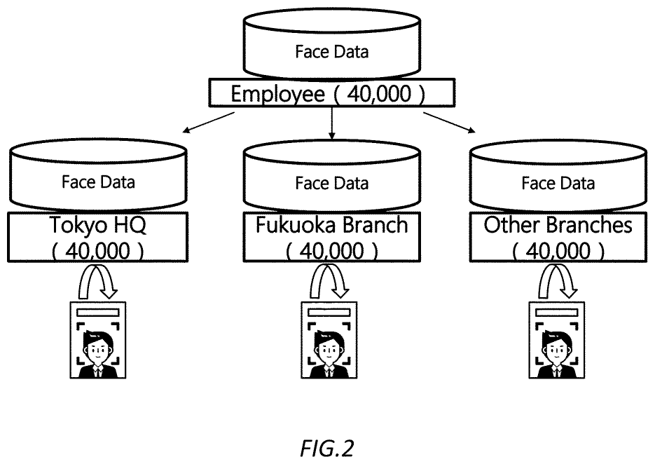

In the example illustrated in FIG. 2, the face authentication data of all 40,000 employees is stored in one server, and the face authentication data of 40,000 people is also copied to the authentication device in each site. In comparison to the example illustrated in FIG. 1, the dependency on the network environment is lower, and the response time may be faster, but the number of pieces of authentication data as the population for the authentication process is the maximum number, and the storage capacity for the face authentication data of 160,000 people in total is also needed.

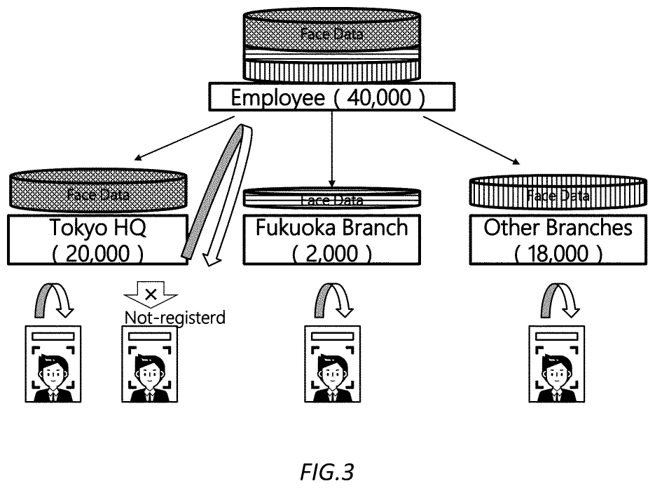

In the example illustrated in FIG. 3, the face authentication data of all 40,000 employees is stored in one server, and the face authentication data of the employees at each site is also copied to the authentication device of each site. In the example illustrated in the figure, the face authentication data of 20,000 employees belonging to the Tokyo headquarters is copied to the authentication device of the Tokyo headquarters, the face authentication data of 2,000 people belonging to the Fukuoka branch is copied to the authentication device of the Fukuoka branch, and the face authentication data of 18,000 people belonging to other branches is copied to the authentication devices of the other branches. Because the face authentication data stored in the authentication device of each site is less in comparison to the example illustrated in FIG. 2, the authentication accuracy may be high, and the response time may be faster. However, for example, if an employee belonging to the Fukuoka branch goes on a business trip to the Tokyo headquarters, the authentication device of which does not store the face authentication data of the employee, the face authentication data stored in the server is referred to, and two-step authentication is required.

In contrast, in the system 10 according to the present embodiment, in which, for example, all face authentication data is stored in one server, if the authentication device performs authentication of a target person using the face authentication data stored in the server and the authentication is successful, it caches the face authentication data of the target person. In this way, if the authentication device subsequently authenticates the target person, it can perform the authentication by using the cached face authentication data. In addition, if the period during which the face authentication data of the person is not used reaches a predetermined period, the authentication device deletes the face authentication data. In this way, the number of pieces of face authentication data stored in the authentication device can be appropriately reduced, which can prevent a decrease in the authentication accuracy, prevent a slow response time, or reduce the risk of data leak.

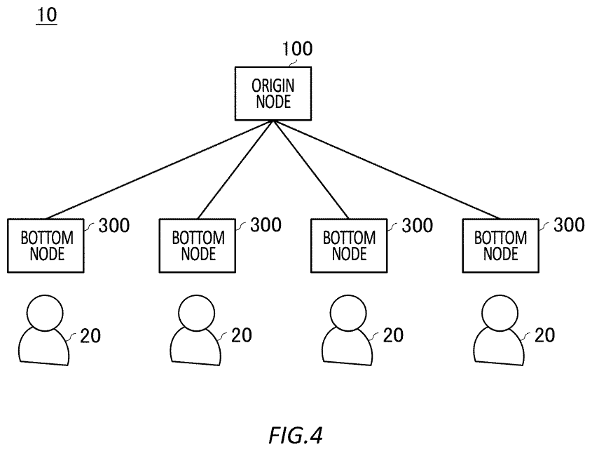

FIG. 4 schematically illustrates an example of a system 10. The system 10 includes an origin node 100. The system 10 includes a plurality of bottom nodes 300. The number of bottom nodes 300 included in the system 10 may be any number.

The origin node 100 is, for example, a server. The origin node 100 may be constituted of one or more devices on the cloud.

The bottom node 300 is, for example, a server. The bottom node 300 may be constituted of one or more devices on the cloud. The bottom node 300 may be an edge device.

The origin node 100 stores the target-related data related to any target. The origin node 100 stores a plurality of pieces of target-related data. The origin node 100 may store all registered target-related data.

The examples of any target include, but not limited to, a living thing such as a person, a means of transportation such as a vehicle, and a legal entity such as a company, a place, and the like. The target-related data may be, for example, attribute data indicating an attribute of the target.

The target-related data may be, for example, the data used for the authentication of the target. As a specific example, the target-related data may be individual-related data used for the authentication of an individual. The individual-related data may be the data used for biometric authentication of an individual. For example, the individual-related data is the data for face authentication. For example, the individual-related data is the data for fingerprint authentication. For example, the individual-related data is the data for voice spectrum authentication. For example, the individual-related data is the data for iris authentication. For example, the individual-related data is the data for vein authentication. For example, the individual-related data is the data for palm print authentication. The individual-related data may be the data for other biometric authentication. As a specific example, the target-related data may be the vehicle-related data used for the authentication of a vehicle. The vehicle-related data may be an exterior feature of the vehicle, the vehicle number, and the like.

The target-related data may be, for example, data related to the activity of the target. As a specific example, the target-related data may be individual-related data related to the activity of an individual. The individual-related data may be, for example, activity-related data related to the activity of an individual. For example, the activity-related data is wallet data such as the name and attribute of the wallet of an individual. For example, the activity-related data is point-related data related to the point possessed by an individual. The activity-related data may be another type of data.

The bottom node 300 stores the target-related data received from the origin node 100. The bottom node 300 provides a service using the target-related data to a provision target, which is the target to which the service is provided. For example, the bottom node 300 provides a service using the target-related data to a target person 20. For example, the bottom node 300 uses the target-related data to authenticate the target person 20 and provides a service according to the authentication result.

As a specific example, the bottom node 300 performs face authentication of the target person 20, and, if the authentication is successful, performs control such as allowing the target person 20 to pass through the gate installed at the entrance of a company building.

The bottom node 300 first performs face authentication of the target person 20 using the target-related data stored therein in response to the request from the target person 20, and, if the authentication is successful, permits the target person 20 to pass through the gate. If the authentication fails, the bottom node 300 performs the face authentication of the target person 20 using the target-related data stored in the origin node 100, or, if the authentication is successful, the bottom node 300 permits the target person 20 to pass through the gate and also caches the target-related data of the target person 20. In this way, from the next time onwards, the authentication can be performed for the target person 20 using the cached target-related data without using the target-related data stored in the origin node 100. If the authentication fails even using the target-related data of the origin node 100, the bottom node 300 may not allow the target person 20 to pass through the gate.

The bottom node 300 may delete the target-related data meeting a predetermined condition among the target-related data stored therein. For example, the bottom node 300 deletes the target-related data that remains unused for a predetermined period. For example, if the storage capacity of the bottom node 300 exceeds a predetermined capacity threshold, the bottom node 300 preferentially deletes the target-related data that remains unused for a longer period. These are examples, and the bottom node 300 may delete the target-related data according to other conditions. In this way, the target-related data that is less needed is deleted, and the number of pieces of authentication data as the population for the authentication process in the bottom node 300 can be appropriately reduced.

In the initial state, the bottom node 300 may store only a part of a plurality of pieces of target-related data stored in the origin node 100, may store all of them, or may store none of them.

For example, in the initial state, each of the plurality of bottom nodes 300 stores a part of the plurality of pieces of target-related data stored in the origin node 100. As a specific example, if the origin node 100 stores the target-related data of all employees in one company, the bottom node 300 arranged in each site stores the target-related data of the employees belonging to each site. In this case, the bottom node 300 can perform authentication using the target-related data stored therein for the employee belonging to its own site. The bottom node 300 does not authenticate an employee belonging to another site using the target-related data stored therein, but authenticates the employee using the target-related data of the origin node 100. In this case, the bottom node 300 caches the target-related data of the employee. In this way, if it subsequently authenticates the employee, it can perform authentication using the target-related data stored therein. Then, if the target-related data of the employee remains unused for a particular period, the bottom node 300 deletes the target-related data. In this way, for example, in a case of the situation where an employee of another site goes on a business trip to its own site for few days, the target-related data of the employee is stored during a period of the business trip to allow the authentication of the employee with one step authentication, while the target-related data of the employee can be deleted when a particular period elapses after the business trip of the employee ends.

In addition, for example, in the initial state, each of the plurality of bottom nodes 300 stores all of the plurality of pieces of target-related data stored in the origin node 100. As a specific example, if the origin node 100 stores the target-related data of all employees in one company, the bottom node 300 arranged in each site stores the target-related data of all employees. In this case, the bottom node 300 can initially perform authentication using the target-related data stored therein when an employee of any site comes. Then, as the time elapses, the bottom node 300 deletes the target-related data of the employees who do not visit its own site, which can optimize the state of the stored target-related data.

In addition, for example, in the initial state, each of the plurality of bottom nodes 300 stores no target-related data. As a specific example, if the origin node 100 stores the target-related data of all employees in one company, the bottom node 300 arranged in each site stores none of the target-related data. In this case, the bottom node 300 initially performs authentication using the target-related data of the origin node 100 when an employee of any site comes. However, as the time elapses, the bottom node 300 stores the target-related data of the employees who visit its own site, which can optimize the state of the stored target-related data.

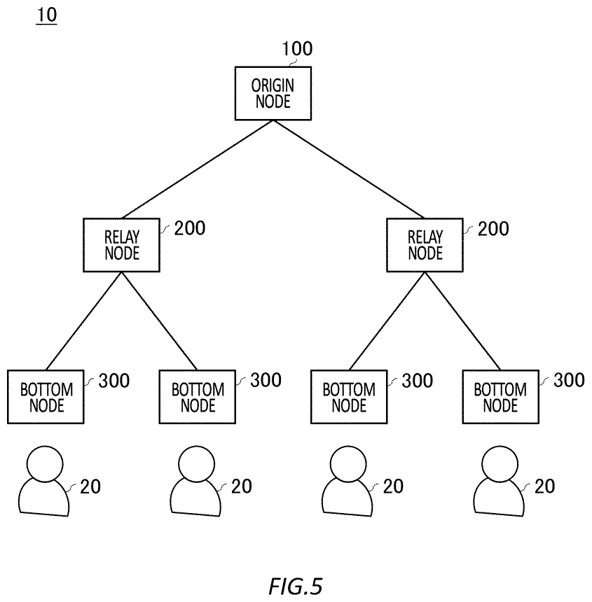

FIG. 5 schematically illustrates an example of a system 10. The system 10 may include, in addition to the origin node 100 and the plurality of bottom nodes 300, one or more relay nodes 200 located at a level between the origin node 100 and the plurality of bottom nodes 300.

The relay node 200 is, for example, a server. The relay node 200 may be constituted of one or more devices on the cloud.

In the present example, for example, the bottom node 300 performs face authentication of the target person 20 using the stored target-related data, and, if the authentication is successful, permits the target person 20 to pass through the gate. If the authentication fails, the bottom node 300 performs the face authentication of the target person 20 using the target-related data stored in the relay node 200, or, if the authentication is successful, the bottom node 300 permits the target person 20 to pass through the gate and also caches the target-related data of the target person 20. If the authentication fails even using the target-related data of the relay node 200, the bottom node 300 performs the face authentication of the target person 20 using the target-related data stored in the origin node 100, or, if the authentication is successful, the bottom node 300 permits the target person 20 to pass through the gate and also caches the target-related data of the target person 20. If the authentication fails even using the target-related data of the origin node 100, the bottom node 300 does not allow the target person 20 to pass through the gate.

The bottom node 300 deletes the target-related data meeting a predetermined condition among the stored target-related data and reports the deleted target-related data to a higher relay node 200. For example, the bottom node 300 deletes the target-related data that remains unused for a predetermined period. For example, if the storage capacity of the bottom node 300 exceeds a predetermined capacity threshold, the bottom node 300 preferentially deletes the target-related data that remains unused for a longer period. These are examples, and the bottom node 300 may delete the target-related data according to other conditions.

If the relay node 200 receiving the report does not store the reported target-related data, it stores the target-related data. In this way, if the target person 20 visits the site of the bottom node 300 after the bottom node 300 deletes the target-related data, the bottom node 300 can authenticate the target person 20 using the target-related data stored in the relay node 200 without referring to the target-related data of the origin node 100.

If the relay node 200 has stored the reported target-related data, it stores only the target-related data with a newer timestamp, among the reported target-related data and the stored target-related data. In this way, for example, in the case where a first bottom node 300 and a second bottom node 300 are arranged lower than one relay node 200, if the report is received from the second bottom node 300 after the target-related data is stored according to the report from the first bottom node 300, newer target-related data can be stored.

The relay node 200 may delete the target-related data meeting a predetermined condition among the stored target-related data. For example, the relay node 200 deletes the target-related data that remains unused for a predetermined period. For example, if the storage capacity of the relay node 200 exceeds a predetermined capacity threshold, the relay node 200 preferentially deletes the target-related data that remains unused for a longer period. These are examples, and the relay node 200 may delete the target-related data according to other conditions.

In the system 10, the bottom node 300 may delete the target-related data that remains unused for a first period among the stored target-related data, and the relay node 200 may delete the target-related data that remains unused for a second period, which is longer than the first period among the stored target-related data. For example, the bottom node 300 deletes the target-related data that remains unused for seven days, and the relay node 200 deletes the target-related data that remains unused for thirty days. In this way, the overall optimization of the entire target-related data in the system 10 can be achieved.

As another example embodiment, if the bottom node 300 fails to perform authentication using the target-related data of the relay node 200 and performs the face authentication of the target person 20 using the target-related data stored in the origin node 100 and the authentication is successful, the bottom node 300 may not cache the target-related data but the relay node 200 may cache the target-related data. Specifically, if the bottom node 300 performs the face authentication of the target person 20 using the stored target-related data and the authentication is successful, the bottom node 300 permits the target person 20 to pass through the gate. If the authentication fails, the bottom node 300 performs the face authentication of the target person 20 using the target-related data stored in the relay node 200, or, if the authentication is successful, the bottom node 300 permits the target person 20 to pass through the gate and also caches the target-related data of the target person 20. If the authentication fails even using the target-related data of the relay node 200, the bottom node 300 performs the face authentication of the target person 20 using the target-related data stored in the origin node 100, or, if the authentication is successful, the bottom node 300 permits the target person 20 to pass through the gate. Then, the relay node 200 caches the target-related data.

In the above-described example embodiment, it is mainly described that if the bottom node 300 performs authentication of the target person 20 using the target-related data at a higher level and the authentication is successful, it caches the target-related data, but this is not limiting. In another example embodiment, for example, in a case where the bottom node 300 attempts to use target-related data of the target person 20 according to any condition, if it stores target-related data therein, it uses the target-related data; if it does not store the target-related data therein and the relay node 200 stores the target-related data, the bottom node 300 uses the target-related data; or if the relay node 200 does not store the target-related data, the bottom node 300 uses the target-related data stored in the origin node 100 and caches the target-related data after use.

As a specific example, a case is described where the system 10 cooperates with a wallet management system that manages the wallet data of the target person 20. The origin node 100 stores the wallet data of all registered target persons 20. In a case of the situation where the wallet data of the target person 20 is needed, the bottom node 300 checks whether or not it stores the wallet data of the target person 20 therein, and if no, acquires it from the higher level for cache. If the wallet data of the target person 20 is stored in the higher relay node 200, the bottom node 300 acquires the wallet data from the relay node 200; or if it is not stored in the higher relay node 200, the bottom node 300 acquires the wallet data from the origin node 100.

The situation where the wallet data of the target person 20 is needed is, for example, a case where the utilization request for the wallet from the target person 20 is received. For example, the bottom node 300 receives the utilization request for the wallet from the target person 20 by communicating with a communication terminal such as a smartphone possessed by the target person 20.

For example, the situation where the wallet data of the target person 20 is needed may be a case where the target person 20 is located near the bottom node 300, a case where the target person 20 is located within a corresponding area of the bottom node 300, and the like. For example, the bottom node 300 determines that it is the situation where the wallet data of the target person 20 is needed if it acquires the location information of the target person 20 and the location information meets a condition. For example, the bottom node 300 acquires the location information obtained through positioning by the smartphone possessed by the target person 20 and the like. The positioning may be performed by using any known positioning approach such as global navigation satellite system (GNSS) positioning, Wi-Fi (registered trademark) positioning, base station positioning, and the like. The bottom node 300 may acquire the location information of the target person 20 by cooperating with a system such as a position management system using Bluetooth (registered trademark) connection information and a position management system using a monitoring camera.

The bottom node 300 provides a service that uses the wallet data of the target person 20. For example, the bottom node 300 determines whether or not the wallet can be used and, if it can be used, provides a wallet service that cooperates with the wallet management system.

Although in FIG. 5 a case is exemplified in which the system 10 is constituted of three levels: a layer of the origin node 100, a layer of the relay node 200, and a layer of the bottom node 300, the system 10 may be constituted of four or more levels. In other words, the system 10 may be constituted of a layer of the origin node 100, two or more layers of the relay node 200, and a layer of the bottom node 300.

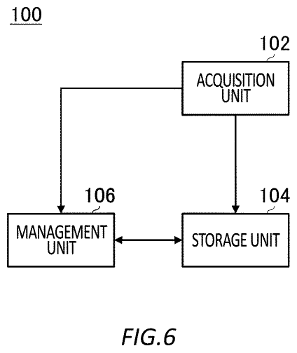

FIG. 6 schematically illustrates an example of a functional configuration of the origin node 100. The origin node 100 includes an acquisition unit 102, a storage unit 104, and a management unit 106.

The acquisition unit 102 acquires various types of data. The acquisition unit 102 may acquire a plurality of pieces of target-related data. The acquisition unit 102 may acquire all registered target-related data. The acquisition unit 102 stores the acquired plurality of pieces of target-related data in the storage unit 104. The storage unit 104 may be an example of the origin storage unit.

The management unit 106 manages the data stored in the storage unit 104. The management unit 106 may manage the target-related data stored in the storage unit 104. The management unit 106 may be an example of the origin management unit.

For example, the management unit 106 provides the target-related data stored in the storage unit 104 to a plurality of bottom nodes 300. As the initial state, the management unit 106 may divide the plurality of pieces of target-related data stored in the storage unit 104 and provide them to each of the plurality of bottom nodes 300. As the initial state, the management unit 106 may provide all the plurality of pieces of target-related data stored in the storage unit 104 to each of the plurality of bottom nodes 300. As the initial state, the management unit 106 may not provide any target-related data stored in the storage unit 104 to the plurality of bottom nodes 300.

The management unit 106 may provide the target-related data to the bottom node 300 in response to the request from the bottom node 300. For example, if the bottom node 300 does not store target-related data of the provision target, which is the target to which the service is provided, the management unit 106 provides the target-related data of the provision target to the bottom node 300 in response to the request from the bottom node 300.

The management unit 106 may provide the target-related data of the provision target to the bottom node 300 in advance, depending on the situation of the provision target. For example, if the management unit 106 determines to provide the target-related data of the provision target to the bottom node 300 in advance based on the schedule information of the provision target, it provides the target-related data of the provision target to the bottom node 300.

As the specific example, usually, if the target person 20 using the first bottom node 300 is going to use the second bottom node 300 for a reason such as a business trip and transfer, the management unit 106 provides the target-related data of the target person 20 to the second bottom node 300. In this way, even in the situation where the target person 20 moves to the position corresponding to the second bottom node 300 for the reason such as a business trip and transfer and uses the second bottom node 300 for the first time, the second bottom node 300 can authenticate the target person 20 or provide a service to the target person 20 using the target-related data stored therein.

The management unit 106 may update or delete the target-related data stored in the storage unit 104. For example, the management unit 106 deletes the specified target-related data among the plurality of pieces of target-related data stored in the storage unit 104 according to the instruction from the administrator of the system 10. As a specific example, in a case where the target-related data is the data of an employee in one company and the target-related data is no longer needed because the employee quits the company or the like, the target-related data of the employee is deleted according to the instruction from the administrator of the system 10.

If the management unit 106 deletes target-related data, it reports the deleted target-related data to the relay node 200 and the bottom node 300. The management unit 106 may report the deleted target-related data to all relay nodes 200 and bottom nodes 300 arranged lower than the origin node 100.

For example, the management unit 106 updates the specified target-related data among the plurality of pieces of target-related data stored in the storage unit 104 according to the instruction from the administrator of the system 10. If the management unit 106 updates target-related data, it reports the updated target-related data to the relay node 200 and the bottom node 300. The management unit 106 may report the updated target-related data to all relay nodes 200 and bottom nodes 300 arranged lower than the origin node 100.

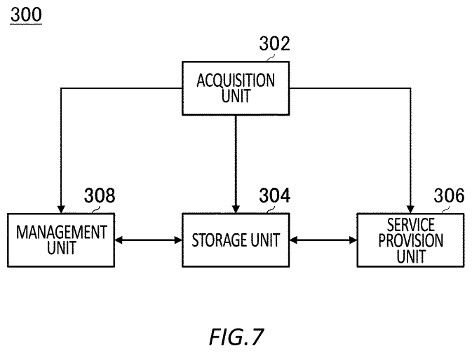

FIG. 7 schematically illustrates an example of the functional configuration of the bottom node 300. The bottom node 300 includes an acquisition unit 302, a storage unit 304, a service provision unit 306, and a management unit 308.

The acquisition unit 302 acquires various types of data. The acquisition unit 302 may acquire the target-related data received from the origin node 100. The acquisition unit 302 stores the acquired target-related data in the storage unit 304. The storage unit 304 may be an example of the bottom storage unit.

The service provision unit 306 provides a service using the target-related data to a provision target, which is the target to which the service is provided. In a case where the relay node 200 is not arranged higher than the bottom node 300, if the target-related data corresponding to the provision target is stored in the storage unit 304, the service provision unit 306 provides a service using the target-related data to the provision target; and if the target-related data corresponding to the provision target is not stored in the storage unit 304 and is stored in the origin node 100, the service provision unit 306 provides a service using the target-related data stored in the origin node 100 to the provision target and stores the target-related data in the storage unit 304.

In a case where the relay node 200 is arranged higher than the bottom node 300, if the target-related data corresponding to the provision target is stored in the storage unit 304, the service provision unit 306 provides a service using the target-related data to the provision target; if the target-related data corresponding to the provision target is not stored in the storage unit 304 and is stored in the higher relay node 200, the service provision unit 306 provides the service using the target-related data to the provision target and stores the target-related data in the storage unit 304; and if the target-related data corresponding to the provision target is not stored in the storage unit 304 and the relay node 200 and is stored in the origin node 100, the service provision unit 306 provides a service using the target-related data to the provision target and stores the target-related data in the storage unit 304.

The management unit 308 manages the target-related data stored in the storage unit 304. The management unit 308 may be an example of the bottom management unit. The management unit 308 deletes, from the storage unit 304, the target-related data meeting a predetermined condition among the target-related data stored in the storage unit 304 and reports the deleted target-related data to the higher relay node 200.

For example, the management unit 308 deletes, from the storage unit 304, the target-related data that remains unused for a predetermined period among the target-related data stored in the storage unit 304. The management unit 308 may delete, from the storage unit 304, the target-related data that remains unused for a period that depends on the attribute of the target corresponding to the target-related data among the target-related data stored in the storage unit 304. If the target is a person, the attribute of the target may be an age, a gender, a status, a belonging, and the like. If the target is a vehicle, the attribute of the target may be the name, type, color, size, performance, function, and the like of the vehicle. If the target is a company, the attribute of the target may be the name, type, field, size, and the like of the company. If the target is a place, the attribute of the target may be the position, type, size, and the like.

In a case where the target is a person, for example, a first status is assigned a longer period than a second status, which is lower than the first status. The management unit 308 deletes the target-related data that remains unused for a longer period when the status of the person corresponding to the target-related data is higher. In this way, the individual-related data of a person with a higher status can be cached in various bottom nodes 300 for a longer period.

For example, an organization corresponding to the bottom node 300 is assigned a longer period than an organization that does not correspond to the bottom node 300. The management unit 308 deletes the target-related data that remains unused for a period that depends on the organization to which the person corresponding to the target-related data belongs. In this way, the target-related data of the person who belongs to the organization corresponding to the bottom node 300 can be cached in the bottom node 300 for a longer period.

For example, the management unit 308 may delete, from the storage unit 304, the target-related data with a usage frequency lower than a predetermined frequency among the target-related data stored in the storage unit 304. The management unit 308 may delete, from the storage unit 304, the target-related data with a usage frequency lower than the frequency that depends on the attribute of the target corresponding to the target-related data among the target-related data stored in the storage unit 304.

If the storage capacity of the bottom node 300 exceeds a predetermined capacity threshold, the management unit 308 may preferentially delete the target-related data that remains unused for a longer period among the target-related data stored in the storage unit 304. For example, if the storage capacity of the bottom node 300 exceeds a predetermined capacity threshold, the management unit 308 deletes the target-related data in the descending order of the period during which it remains unused, until the storage capacity of the bottom node 300 becomes less than the predetermined capacity threshold or another capacity threshold that is less than the predetermined capacity threshold. If the storage capacity of the bottom node 300 exceeds a predetermined capacity threshold, the management unit 308 may preferentially delete the target-related data with less usage frequency among the target-related data stored in the storage unit 304. For example, if the storage capacity of the bottom node 300 exceeds a predetermined capacity threshold, the management unit 308 deletes the target-related data in the ascending order of the usage frequency, until the storage capacity of the bottom node 300 becomes less than the predetermined capacity threshold or another capacity threshold that is less than the predetermined capacity threshold. If the storage capacity of the bottom node 300 exceeds a predetermined capacity threshold, the management unit 308 may randomly delete the target-related data stored in the storage unit 304.

The management unit 308 may delete, from the storage unit 304, the target-related data meeting the condition related to the position of the target corresponding to the target-related data among the target-related data stored in the storage unit 304. For example, the management unit 308 acquires the location information of the provision target, which is the target to which the service is provided, and, if the location information meets the condition, deletes the target-related data corresponding to the provision target from the storage unit 304. The location information may be acquired by the acquisition unit 102. For example, the acquisition unit 102 acquires the location information obtained through positioning by the communication terminal possessed by the provision target. For example, if the provision target is a person, the acquisition unit 102 acquires the location information obtained through positioning by the smartphone or the like possessed by the provision target. The positioning may be performed by using any known positioning approach such as GNSS positioning, Wi-Fi positioning, base station positioning, or the like. The acquisition unit 102 may acquire the location information of the provision target by cooperating with the system such as a position management system using Bluetooth connection information and a position management system using a monitoring camera.

For example, if the position of the target corresponding to the target-related data is away from the position corresponding to the bottom node 300 by a predetermined distance or more, the management unit 308 deletes the target-related data from the storage unit 304. In this way, for example, if a person who has been in and out of the site corresponding to the bottom node 300 due to a business trip or the like finishes the business trip, the management unit 308 can delete the target-related data of the person. If the position of the target corresponding to the target-related data is away from the position corresponding to the bottom node 300 by a distance according to the attribute of the target or more, the management unit 308 may delete the target-related data from the storage unit 304.

If the storage capacity of the bottom node 300 exceeds a predetermined capacity threshold, the management unit 308 may preferentially delete the target-related data for which the distance between the position of the target corresponding to the target-related data and the position corresponding to the bottom node 300 is longer, among the target-related data stored in the storage unit 304. For example, if the storage capacity of the bottom node 300 exceeds a predetermined capacity threshold, the management unit 308 deletes the target-related data in the descending order of the distance between the position of the target corresponding to the target-related data and the position corresponding to the bottom node 300, until the storage capacity of the bottom node 300 becomes less than the predetermined capacity threshold or another capacity threshold that is less than the predetermined capacity threshold.

The management unit 308 may delete, from the storage unit 304, the target-related data with the schedule information of the target corresponding to the target-related data meeting the condition, among the target-related data stored in the storage unit 304. The schedule information may be acquired by the acquisition unit 102. The acquisition unit 102 may acquire the schedule information of the target from the schedule management system that manages the schedule of the target.

For example, the management unit 308 deletes, from the storage unit 304, the target-related data of the target indicated to be moving away from the position corresponding to the bottom node 300 by the schedule information. For example, in a case where the target is a person, if the schedule information indicates that business trip or transfer of a person who visits the position corresponding to the bottom node 300 due to the business trip or transfer ends, the management unit 308 deletes the target-related data of the person from the storage unit 304.

If the management unit 308 receives the report of the deleted target-related data from the management unit 106 of the origin node 100 and the reported target-related data is stored in the storage unit 304, the management unit 308 may delete the target-related data from the storage unit 304. If the reported target-related data is stored in the storage unit 304, the management unit 308 may determine the schedule to delete the target-related data from the storage unit 304 and may delete the target-related data according to the determined schedule.

If the management unit 308 receives the report of the updated target-related data from the management unit 106 of the origin node 100 and the reported target-related data is stored in the storage unit 304, the management unit 308 may delete the target-related data from the storage unit 304. The management unit 308 may acquire the updated target-related data from the origin node 100 to replace the target-related data stored in the storage unit 304.

The management unit 308 may periodically inquire the origin node 100 for the target-related data stored in the storage unit 304. If the result of the inquiry indicates that the target-related data has been deleted in the origin node 100, the management unit 308 may delete the deleted target-related data from the storage unit 304, or may determine the schedule for deletion and perform the deletion according to the determined schedule. If the target-related data is found to be updated in the origin node 100 as a result of the inquiry, the management unit 308 may delete the target-related data from the storage unit 304, or may acquire the updated target-related data from the origin node 100 to replace the target-related data stored in the storage unit 304.

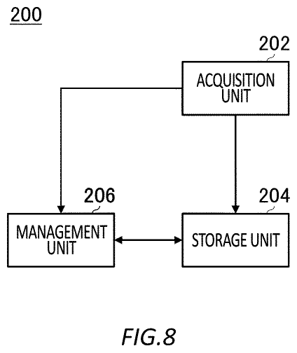

FIG. 8 schematically illustrates an example of the functional configuration of the relay node 200. The relay node 200 includes an acquisition unit 202, a storage unit 204, and a management unit 206.

The acquisition unit 202 acquires various types of data. The acquisition unit 202 may acquire the target-related data. The acquisition unit 202 stores the acquired target-related data in the storage unit 204. The storage unit 204 may be an example of the relay storage unit.

The management unit 206 manages the data stored in the acquisition unit 202. The management unit 206 may be an example of the relay management unit. If the management unit 206 receives the report of the deleted target-related data from the lower bottom node 300 and the reported target-related data is not stored in the storage unit 204, it stores the target-related data in the storage unit 204. If the management unit 206 receives the report of the deleted target-related data from the lower bottom node 300 and the reported target-related data is stored in the storage unit 204, the management unit 206 may store, in the storage unit 204, only the target-related data with a newer timestamp among the target-related data stored in the storage unit 204 and the reported target-related data.

The management unit 206 may delete, from the storage unit 204, the target-related data meeting a predetermined condition among the target-related data stored in the storage unit 204. For example, the management unit 206 deletes, from the storage unit 204, the target-related data that remains unused for a predetermined period, among the target-related data stored in the storage unit 204. The management unit 206 may delete, from the storage unit 204, the target-related data that remains unused for a period that depends on the attribute of the target corresponding to the target-related data, among the target-related data stored in the storage unit 204.

The management unit 308 and the management unit 206 may delete the target-related data according to different standards of period. For example, the management unit 308 deletes, from the storage unit 304, the target-related data that remains unused for a first period, among the target-related data stored in the storage unit 304, while the management unit 206 deletes, from the storage unit 204, the target-related data that remains unused for a second period, which is longer than a first period, among the target-related data stored in the storage unit 204.

For example, the management unit 206 may delete, from the storage unit 204, the target-related data with a usage frequency that is lower than a predetermined frequency, among the target-related data stored in the storage unit 204. The management unit 206 may delete, from the storage unit 204, the target-related data with a usage frequency that is lower than the frequency that depends on the attribute of the target corresponding to the target-related data, among the target-related data stored in the storage unit 204.

If the storage capacity of the relay node 200 exceeds a predetermined capacity threshold, the management unit 206 may preferentially delete the target-related data that remains unused for a longer period, among the target-related data stored in the storage unit 204. For example, if the storage capacity of the relay node 200 exceeds a predetermined capacity threshold, the management unit 206 deletes the target-related data in the descending order of the period during which it remains unused, until the storage capacity of the relay node 200 becomes less than the predetermined capacity threshold or another capacity threshold that is less than the predetermined capacity threshold. If the storage capacity of the relay node 200 exceeds a predetermined capacity, the management unit 206 may preferentially delete the target-related data with less usage frequency among the target-related data stored in the storage unit 204. For example, if the storage capacity of the relay node 200 exceeds a predetermined capacity threshold, the management unit 206 deletes the target-related data in the ascending order of the usage frequency, until the storage capacity of the relay node 200 becomes less than the predetermined capacity threshold or another capacity threshold that is less than the predetermined capacity threshold. If the storage capacity of the relay node 200 exceeds a predetermined capacity, the management unit 206 may randomly delete the target-related data stored in the storage unit 204.

Like the management unit 308, the management unit 206 may delete, from the storage unit 204, the target-related data meeting the condition related to the position of the target corresponding to the target-related data, among the target-related data stored in the storage unit 204. Like the management unit 308, if the storage capacity of the relay node 200 exceeds a predetermined capacity threshold, the management unit 206 may preferentially delete the target-related data with a longer distance between the position of the target corresponding to the target-related data and the position corresponding to the relay node 200, among the target-related data stored in the storage unit 204.

Like the management unit 308, the management unit 206 may delete, from the storage unit 204, the target-related data with the schedule information of the target corresponding to the target-related data meeting the condition, among the target-related data stored in the storage unit 204.

If the management unit 308 receives the report of the deleted target-related data from the management unit 106 of the origin node 100 and the reported target-related data is stored in the storage unit 204, the management unit 206 may delete the target-related data from the storage unit 204. If the reported target-related data is stored in the storage unit 204, the management unit 206 may determine the schedule to delete the target-related data from the storage unit 204 and may delete the target-related data according to the determined schedule.

If the management unit 308 receives the report of the updated target-related data from the management unit 106 of the origin node 100 and the reported target-related data is stored in the storage unit 204, the management unit 206 may delete the target-related data from the storage unit 204. The management unit 206 may acquire the updated target-related data from the origin node 100 to replace the target-related data stored in the storage unit 204.

The management unit 206 may periodically inquire the origin node 100 for the target-related data stored in the storage unit 204. If the result of the inquiry indicates that the target-related data has been deleted in the origin node 100, the management unit 206 may delete the deleted target-related data from the storage unit 204, or may determine the schedule for deletion and perform the deletion according to the determined schedule. If the result of the inquiry indicates that the target-related data has been updated in the origin node 100, the management unit 206 may delete the target-related data from the storage unit 204, or may acquire the updated target-related data from the origin node 100 to replace the target-related data stored in the storage unit 204.

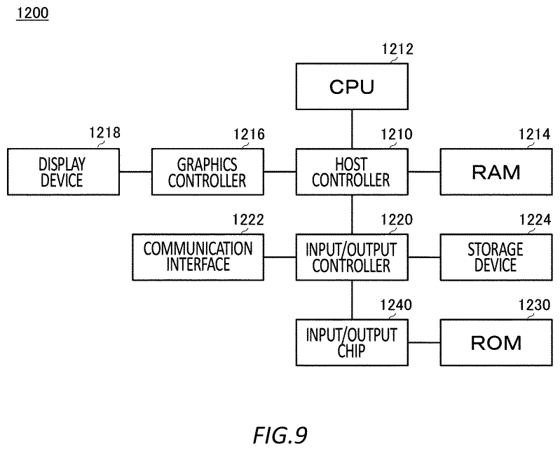

FIG. 9 schematically illustrates an example of the hardware configuration of a computer 1200 that functions as the origin node 100, the relay node 200, or the bottom node 300. A program installed in the computer 1200 can cause the computer 1200 to function as one or more “units” of a device according to the present embodiment, or cause the computer 1200 to perform operations associated with the device or perform said one or more “units” thereof according to the present embodiment, and/or cause the computer 1200 to perform the process according to the present embodiment or perform the steps of the said process. Such a program may be executed by a CPU 1212 to cause the computer 1200 to perform particular operations associated with some or all of the blocks in the flowcharts and block diagrams described in the present specification.

The computer 1200 according to the present embodiment includes the CPU 1212, a RAM 1214, and a graphics controller 1216, which are connected to each other via a host controller 1210. The computer 1200 also includes input/output units such as a communication interface 1222, a storage device 1224, a DVD drive and an IC card drive, which are connected to the host controller 1210 via an input/output controller 1220. The DVD drive may be a DVD-ROM drive, a DVD-RAM drive, and the like. The storage device 1224 may be a hard disk drive, a solid-state drive, and the like. The computer 1200 also includes a ROM 1230 and a legacy input/output unit such as a keyboard, which are connected to the input/output controller 1220 via an input/output chip 1240.

The CPU 1212 operates in accordance with the programs stored in the ROM 1230 and the RAM 1214, thereby controlling each unit. The graphics controller 1216 acquires image data which is generated by the CPU 1212 in a frame buffer or the like provided in the RAM 1214 or in itself so as to cause the image data to be displayed on a display device 1218.

The communication interface 1222 communicates with other electronic devices via a network. The storage device 1224 stores a program and data used by the CPU 1212 in the computer 1200. The DVD drive reads the programs or the data from the DVD-ROM or the like, and provides the storage device 1224 with the programs or the data. The IC card drive reads the program and data from an IC card, and/or writes the program and data to the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer-readable storage medium such as the DVD-ROM or the IC card. The program is read from the computer-readable storage medium, installed into the storage device 1224, RAM 1214, or ROM 1230, which are also examples of a computer-readable storage medium, and executed by the CPU 1212. Information processing written in these programs is read by the computer 1200, and provides cooperation between the programs and the various types of hardware resources described above. A device or method may be configured by achieving the operation or processing of information in accordance with the usage of the computer 1200.

For example, when a communication is performed between the computer 1200 and an external device, the CPU 1212 may execute a communication program loaded in the RAM 1214 and instruct the communication interface 1222 to perform communication processing based on a process written in the communication program. The communication interface 1222, under control of the CPU 1212, reads transmission data stored on a transmission buffer region provided in a recording medium such as the RAM 1214, the storage device 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage device 1224, the DVD drive (DVD-ROM), the IC card, etc., and perform various types of processing on the data on the RAM 1214. Next, the CPU 1212 may write the processed data back into the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information search/replacement, or the like described throughout the present disclosure and designated by instruction sequences of the programs, to write the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the said plurality of entries, and read the attribute value of the second attribute stored in the said entry, thereby acquiring the attribute value of the second attribute associated with the first attribute that meets a predetermined condition.

The above described program or software modules may be stored in the computer-readable storage medium on or near the computer 1200. In addition, a recording medium such as a hard disk or a RAM provided in a server system connected to a dedicated communication network or the Internet can be used as the computer-readable storage medium, thereby providing the program to the computer 1200 via the network.

Blocks in flowcharts and block diagrams in the present embodiments may represent step of processes in which operations are executed or “units” of device responsible for executing operations. A specific step and “unit” may be implemented by a dedicated circuit, a programmable circuit supplied along with a computer readable instruction stored on a computer-readable storage medium, and/or a processor supplied along with the computer-readable instruction stored on the computer-readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer-readable storage medium may include any tangible device capable of storing an instruction executed by an appropriate device, so that the computer-readable storage medium having the instruction stored thereon constitutes a product including an instruction that may be executed in order to provide means for executing an operation designated by a flowchart or a block diagram. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer-readable instructions may include an assembler instruction, an instruction-set-architecture (ISA) instruction, a machine instruction, a machine-dependent instruction, a microcode, a firmware instruction, state-setting data, or either of source code or object code described in any combination of one or more programming languages including an object-oriented programming language such as Smalltalk (registered trademark), JAVA (registered trademark), and C++, or the like, and a conventional procedural programming language such as a “C” programming language or a similar programming language.

The computer-readable instruction may be provided to a general purpose computer, a special purpose computer, or a processor or programmable circuit of another programmable data processing apparatus locally or via a local area network (LAN), a wide area network (WAN) such as the Internet or the like in order that the general purpose computer, the special purpose computer, or the processor or the programmable circuit of another programmable data processing apparatus executes the computer-readable instruction to generate means for executing operations designated by the flowchart or the block diagram. Here, the computer may be a personal computer, or PC, a tablet computer, a smartphone, a workstation, a server computer, a general purpose computer, a special purpose computer, or the like, or may be a computer system to which a plurality of computers are connected. Such computer system to which the plurality of computers are connected is also referred to as a distributed computing system, and is a computer in a broad sense. In the distributed computing system, the plurality of computers collectively execute the program by each of the plurality of computers performing a part of the program and passing the data during program execution between the computers as needed. An example of the processor includes a computer processor, a central processing unit, a processing unit, a microprocessor, a digital signal processor, a controller, a microcontroller, or the like. The computer may include one processor or a plurality of processors. In a multiprocessor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processor is responsible for executing may be determined statically by multiprocessor-aware programming.

While the present invention has been described above by way of the embodiments, the technical scope of the present invention is not limited to the scope described in the above-described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process executed by a device, system, program, and method shown in the claims, embodiments, or diagrams can be achieved in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be executed in this order.

### EXPLANATION OF REFERENCES

10 system;
20 target person;
100 origin node;
102 acquisition unit;
104 storage unit;
106 management unit;
200 relay node;
202 acquisition unit;
204 storage unit;
206 management unit;
300 bottom node;
302 acquisition unit;
304 storage unit;
306 service provision unit;
308 management unit;
1200 computer;
1210 host controller;
1212 CPU;
1214 RAM;
1216 graphics controller;
1218 display device;
1220 input/output controller;
1222 communication interface;
1224 storage device;
1230 ROM;
1240 input/output chip.

What is claimed is:

1. A system comprising:
an origin node having an origin storage unit which stores a plurality of pieces of target-related data;
a plurality of bottom nodes; and
a plurality of relay nodes located at a level between the origin node and the plurality of bottom nodes, wherein
each of the plurality of bottom nodes has:
a bottom storage unit which stores target-related data received from the origin node;
a service provision unit which, if the target-related data corresponding to a provision target, which is a target to which a service is provided, is stored in the bottom storage unit, provides a service using the target-related data to the provision target; if the target-related data corresponding to the provision target is not stored in the bottom storage unit and is stored in higher one of the relay nodes, provides a service using the target-related data to the provision target and stores the target-related data in the bottom storage unit; and if the target-related data corresponding to the provision target is not stored in the bottom storage unit and the relay nodes and is stored in the origin node, provides a service using the target-related data stored in the origin node to the provision target and stores the target-related data in the bottom storage unit; and
a bottom management unit which deletes, from the bottom storage unit, the target-related data meeting a predetermined condition, among the target-related data stored in the bottom storage unit and reports the deleted target-related data to higher one of the relay nodes,
each of the plurality of relay nodes has:
a relay storage unit; and
a relay management unit which stores the target-related data in the relay storage unit if it receives the report from lower one of the plurality of bottom nodes and the reported target-related data is not stored in the relay storage unit, and
the relay management unit deletes, from the relay storage unit, the target-related data meeting a predetermined condition, among the target-related data stored in the relay storage unit.

2. The system according to claim 1, wherein the bottom management unit deletes, from the bottom storage unit, the target-related data which remains unused for a first period, among the target-related data stored in the bottom storage unit, and
the relay management unit deletes, from the relay storage unit, the target-related data which remains unused for a second period, which is longer than the first period, among the target-related data stored in the relay storage unit.

3. The system according to claim 1, wherein if the relay management unit receives the report from lower one of the bottom nodes and the reported target-related data is stored in the relay storage unit, the relay management unit stores, in the relay storage unit, only the target-related data with a newer timestamp among the target-related data stored in the relay storage unit and the reported target-related data.

4. The system according to claim 1, wherein the bottom management unit deletes, from the bottom storage unit, the target-related data that remains unused for a period which depends on an attribute of a target corresponding to the target-related data, among the target-related data stored in the bottom storage unit.

5. The system according to claim 4, wherein if the target is a person, an attribute of the target includes a status of the target and a first status is assigned a longer period than a second status which is lower than the first status.

6. The system according to claim 1, wherein the bottom management unit deletes, from the bottom storage unit, the target-related data with a usage frequency lower than a predetermined frequency, among the target-related data stored in the bottom storage unit, and
the relay management unit deletes, from the relay storage unit, the target-related data with a usage frequency lower than a predetermined frequency, among the target-related data stored in the relay storage unit.

7. The system according to claim 6, wherein the bottom management unit deletes, from the bottom storage unit, the target-related data with a usage frequency lower than a frequency which depends on an attribute of a target corresponding to the target-related data, among the target-related data stored in the bottom storage unit.

8. The system according to claim 1, wherein the bottom management unit deletes, from the bottom storage unit, the target-related data meeting a condition related to a position of a target corresponding to the target-related data, among the target-related data stored in the bottom storage unit.

9. The system according to claim 8, wherein if a position of a target corresponding to the target-related data is away from a position corresponding to the bottom node by a predetermined distance or more, the bottom management unit deletes the target-related data from the bottom storage unit.

10. The system according to claim 9, wherein if a position of a target corresponding to the target-related data is away from a position corresponding to the bottom node by a distance which depends on an attribute of the target or more, the bottom management unit deletes the target-related data from the bottom storage unit.

11. The system according to claim 1, wherein the bottom management unit deletes, from the bottom storage unit, the target-related data with schedule information of a target corresponding to the target-related data meeting a condition, among target-related data stored in the bottom storage unit.

12. The system according to claim 11, wherein the bottom management unit deletes, from the bottom storage unit, the target-related data of a target indicated, by the schedule information, to be away from a position corresponding to the bottom node.

13. The system according to claim 12, wherein if the target is a person and the schedule information indicates that a business trip or transfer of a person who visits a position corresponding to the bottom node due to the business trip or transfer ends, the bottom management unit deletes the target-related data of the person from the bottom storage unit.

14. The system according to claim 1, wherein the target-related data is data used to authenticate a target, and
if the target-related data corresponding to the provision target which is an authentication target is stored in the bottom storage unit, the service provision unit provides an authentication service using the target-related data to the provision target; if the target-related data corresponding to the provision target is not stored in the bottom storage unit and is stored in higher one of the relay nodes, the service provision unit provides an authentication service using the target-related data to the provision target and stores the target-related data in the bottom storage unit; and if the target-related data corresponding to the provision target is not stored in the bottom storage unit and the relay nodes and is stored in the origin node, the service provision unit provides an authentication service using the target-related data to the provision target and stores the target-related data in the bottom storage unit.

15. The system according to claim 14, wherein if the target-related data corresponding to the provision target which is an authentication target is stored in the bottom storage unit, the service provision unit uses the target-related data to perform authentication of the authentication target; and if the target-related data corresponding to the provision target is not stored in the bottom storage unit and is stored in the origin node, the service provision unit uses the target-related data to perform authentication of the authentication target, and stores the target-related data in the bottom storage unit if authentication is successful.

16. The system according to claim 15, wherein the target-related data may be data for face authentication, and
if the target-related data corresponding to the provision target which is an authentication target is stored in the bottom storage unit, the service provision unit uses the target-related data to perform face authentication of the authentication target; and if the target-related data corresponding to the provision target is not stored in the bottom storage unit and is stored in the origin node, the service provision unit uses the target-related data to perform face authentication of the authentication target, and stores the target-related data in the bottom storage unit if authentication is successful.

17. An information processing device, comprising:
a storage unit which stores target-related data received from an origin node which stores a plurality of pieces of target-related data;
a service provision unit which, if the target-related data corresponding to a provision target, which is a target to which a service is provided, is stored in the storage unit, provides a service using the target-related data to the provision target; if the target-related data corresponding to the provision target is not stored in the storage unit and is stored in a relay node higher than the information processing device among a plurality of relay nodes located at a level between the origin node and the information processing device, provides a service using the target-related data to the provision target and stores the target-related data in the storage unit; and if the target-related data corresponding to the provision target is not stored in the storage unit and the relay nodes and is stored in the origin node, provides a service using the target-related data to the provision target and stores the target-related data in the storage unit; and
a bottom management unit which deletes, from the storage unit, the target-related data meeting a predetermined condition, among the target-related data stored in the storage unit, and reports the deleted target-related data to a higher one of the relay nodes.

18. A non-transitory computer-readable storage medium which stores a program which causes a computer to function as:
a storage unit which stores target-related data received from an origin node which stores a plurality of pieces of target-related data;
a service provision unit which, if the target-related data corresponding to a provision target, which is a target to which a service is provided, is stored in the storage unit, provides a service using the target-related data to the provision target; if the target-related data corresponding to the provision target is not stored in the storage unit and is stored in a relay node higher than an information processing device among a plurality of relay nodes located at a level between the origin node and the information processing device, provides a service using the target-related data to the provision target and stores the target-related data in the storage unit; and if the target-related data corresponding to the provision target is not stored in the storage unit and the relay nodes and is stored in the origin node, provides a service using the target-related data to the provision target and stores the target-related data in the storage unit; and
a bottom management unit which deletes, from the storage unit, the target-related data meeting a predetermined condition, among the target-related data stored in the storage unit, and reports the deleted target-related data to a higher one of the relay nodes.

19. A management method performed by a computer, comprising:
storing, in a storage unit, target-related data received from an origin node which stores a plurality of pieces of target-related data;
if the target-related data corresponding to a provision target, which is a target to which a service is provided, is stored in the storage unit, providing a service using the target-related data to the provision target; if the target-related data corresponding to the provision target is not stored in the storage unit and is stored in a relay node higher than the computer among a plurality of relay nodes located at a level between the origin node and the computer, providing a service using the target-related data to the provision target and stores the target-related data in the storage unit; and if the target-related data corresponding to the provision target is not stored in the storage unit and the relay nodes and is stored in the origin node, providing a service using the target-related data to the provision target and stores the target-related data in the storage unit; and
performing bottom management by deleting, from the storage unit, the target-related data meeting a predetermined condition, among the target-related data stored in the storage unit, and reporting the deleted target-related data to a higher one of the relay nodes.
